(19) United States
(12) Patent Application Publication
(10) Pub. No.: US 2015/0154592 A1
(43) Pub. Date: Jun. 4, 2015

(54) AUTHORIZING A TRANSACTION BETWEEN A CLIENT DEVICE AND A SERVER USING A SCANNABLE CODE

(71) Applicants: James Ioannidis, Palo Alto, CA (US); Henri Normak, Harjumaa (EE); Mary Minno, Palo Alto, CA (US)

(72) Inventors: James Ioannidis, Palo Alto, CA (US); Henri Normak, Harjumaa (EE); Mary Minno, Palo Alto, CA (US)

(21) Appl. No.: 14/406,187

(22) PCT Filed: Jun. 10, 2013
(86) PCT No.: PCT/US2013/045042

§ 371 Date: Dec. 5, 2014

Related U.S. Application Data
(63) Continuation-in-part of application No. 13/544,424, filed on Jul. 9, 2012.
(60) Provisional application No. 61/657,303, filed on Jun. 8, 2012.

(51) Int. Cl. G06Q 20/38; G06Q 20/20

(52) U.S. Cl. CPC G06Q 20/382; G06Q 20/202

(57) ABSTRACT

Exemplary methods, apparatuses, and systems include a first server transmitting, to a first client device, a scannable code for display on the first client device. The scannable code encodes a session identifier for a session between the first client device and the first server. The first server receives a transaction identifier to authenticate a transaction within the session between the first client device and the first server. The transaction identifier is transmitted to the first server in response to a second client device scanning and decoding the scannable code displayed on the first client device to obtain the session identifier. The first server transmits an indication of a successful authentication to the first client device in response to the received transaction identifier.

This application claims priority to U.S. Provisional Application No. 61/657,303 filed on Jun. 8, 2012 by James Ioannidis and titled “Scan-Based Universal Shopping Cart and Checkout” and U.S. patent application Ser. No. 13/544,424 filed on Jul. 9, 2012 titled “A System, Computer Program Product and Computer Implemented Method for Purchasing Items From A Merchant.”

### FIELD OF INVENTION

Embodiments described herein relate to the authentication of a transaction between devices and to a point-of-sale system, computer program product, and computer-implemented method for using a mobile device as a point of sale system.

### BACKGROUND OF THE INVENTION

Traditionally, to purchase an item at a merchant, a consumer user would have to select the item and request the merchant to process payment for the item at a checkout location. This process could be time consuming for the consumer user, i.e., the checkout location may have several people waiting for the merchant to process payment for their purchases. To handle such issues, many merchants began employing self-serve check out stands in their stores. Such systems allowed a consumer user to scan their own purchases using merchant equipment and then provide payment for the purchases via, e.g., credit card. Such systems had the promise of being a convenient solution to long lines at checkout locations, but have several problems. First, consumer users have difficulty locating and scanning traditional product bar codes. Second, many consumer users are not adept at processing coupons to receive discounts for their purchases. Finally, many consumer users are impatient with the system causing system crashes and requiring attendants to assist in checkout. Accordingly, these self-serve kiosks are not widely adopted in stores for the purchase of items.

Moreover, for some items, many consumer users want to see the items before purchase, e.g., house wares, clothing, electronics, furniture, etc. However, when the consumer user is in the store, they are only able to comparison shop for the same item by connecting to the internet on, e.g., a mobile device and searching for the product. This can be time consuming, and frustrating for a merchant that may be helping the consumer user. Moreover, if a consumer user finds a cheaper price for the product online, many merchants may be willing to match the online price, but are unable to because the consumer user does not inform the merchant of the reason for their non-purchase from the merchant. In other instances, the merchant may have discounts on similar products to those being considered by the consumer user, or may be aware of manufacturer discounts for the item. In such instances, because the merchant is unaware of the reason for the consumer user's non-purchase of an item, it may not make those coupons or discounts available to the consumer user.

A need exists for a method and system that solves the issues identified above.

### SUMMARY OF INVENTION

Exemplary methods, apparatuses, and systems include a first server transmitting, to a first client device, a scannable code for display on the first client device, e.g., in response to a request from the first client device to initiate a transaction. The scannable code encodes a session identifier for a session between the first client device and the first server. A second client device (e.g., a mobile device) scans and decodes the scannable code displayed on the first client device to obtain the session identifier. The second client device transmits stored user data and the decoded session identifier to an authentication server. In one embodiment, the scannable code further encodes a payment amount or other data associated with the transaction, which is also decoded by the second client device and transmitted to the authentication server.

The authentication server generates a transaction identifier using the received user data (and other decoded data if received) to authenticate a transaction within the session between the first client device and the first server. The authentication server transmits the transaction identifier to the first server (e.g., via the first client device or directly). The first server transmits an indication of a successful authentication to the first client device in response receiving the transaction identifier.

In one embodiment, the first server optionally transmits an executable script to the first client device along with the scannable code. The executable script causes the first client device to open a communication channel with the authentication server. In response to receiving the session ID from the second client device and generating a transaction identifier, the authentication server looks up the communication channel using the received session identifier. The authentication server transmits the transaction identifier to the first client device via the established communication channel. The first client device forwards the received transaction identifier to the first server.

In an embodiment in which the transaction identifier is forwarded by the first client device to the first server, the first server optionally establishes a confirmation communication channel with the second server. The first server transmits a request to the authentication server via the confirmation communication channel to confirm the received transaction identifier. The first server receives confirmation of the transaction identifier from the authentication server via the confirmation communication channel. The indication of the successful authentication is transmitted further in response to receiving the confirmation of the transaction identifier. Upon confirming the transaction identifier, the authentication server marks the transaction associated with the session identifier as being complete.

In an alternate embodiment, the first server opens a communication channel with the authentication server. The first server receives a transaction identifier and the session identifier from the authentication server directly via the communication channel.

Embodiments of the invention further include a system for allowing a user to purchase one or more products from a merchant. Such a system comprises a mobile device associated with the user that includes a tangible, non-transitory memory having stored thereon computer instructions for performing a process of receiving product information associated with a product and a merchant identifier associated with the merchant from a code and a process of using the code to facilitate purchasing the product. In some embodiments, the computer instructions execute the steps of prompting the user to scan the code using the mobile device; translating the code to determine at least a product price and merchant identifier; creating a product purchase prompt on a display associated with the mobile device, the product purchase prompt including at least the product price and a checkout tab for selection by the user; responsive to the selection of the checkout tab by the user, transmitting a mobile device identifier associated with the mobile device, product price and merchant identifier to a processing server to thereby facilitate an approval of a transaction between the user and the merchant for the product; and creating a payment approved prompt on the display, responsive to the receipt of approval of the transaction by the processing server.

Embodiments of the invention also include a computer program product comprised of a series of instructions executable on a computer. As such, the computer program product performs a process of receiving product information associated with a product and a merchant identifier associated with the merchant from a code and a process of using the code to facilitate purchasing the product. In some embodiments, the computer program product implementing the steps of prompting the user to scan the code using a mobile device; translating the code to determine at least a product price and merchant identifier; creating a product purchase prompt on a display associated with the mobile device, the product purchase prompt including at least the product price and a checkout tab for selection by the user; responsive to the selection of the checkout tab by the user, transmitting a mobile device identifier associated with the mobile device, product price and merchant identifier to a processing server to thereby facilitate an approval of a transaction between the user and the merchant for the product; and creating a payment approved prompt on the display, responsive to the receipt of approval of the transaction by the processing server.

Embodiments of the invention include a system that allows a user to purchase one or more products from a merchant. Such a system comprises a computer associated with the user and a mobile device that includes a tangible, non-transitory memory having stored thereon computer instructions for performing a process of receiving a product price associated with a product and merchant identifier associated with the merchant from the mobile device and a process of using a mobile device identifier associated with the mobile device to facilitate purchasing the product. In some embodiments, the computer instructions execute the steps of creating an enrollee prompt to allow the user to connect the mobile device to the system, the enrollee prompt obtaining from the user a username, a credit card number associated with a user credit card and the mobile device identifier; linking the mobile device identifier to a system user identifier; matching, responsive to receiving from the mobile device the mobile device identifier, the product price and the merchant identifier, the mobile device with the user identifier; debiting the product price from the user credit card associated with the user identifier; and crediting a merchant account associated with the merchant identifier the purchase price.

Other features and advantages will be apparent from the accompanying drawings and from the detailed description. Additionally, the claims of the present application, as filed, are hereby incorporated by reference.

### BRIEF DESCRIPTION OF THE DRAWINGS

So that the features and advantages of the invention may be understood in more detail, a more particular description of the invention briefly summarized above may be had by reference to the appended drawings, which form a part of this specification. It is to be noted, however, that the drawings illustrate only various embodiments of the invention and are therefore not to be considered limiting of the invention's scope as it may include other effective embodiments as well.

FIG. 1 is a network diagram of a payment processing system including a user mobile device, a communications network and purchasing server according to an embodiment of the invention;

FIG. 2 is an electronic block diagram of a purchasing server for providing access to the system according to an embodiment of the invention;

FIG. 3 is a software block diagram of a purchasing server having a program product in memory thereon including several operation modules according to an embodiment of the invention;

FIG. 4A is an electronic block diagram of a purchasing server of the system according to an embodiment of the invention;

FIG. 4B is a software block diagram of a purchasing server having a program product in memory thereon including several operation modules according to an embodiment of the invention

FIG. 5A is a software flow diagram for obtaining consumer user account information and preferences according to an embodiment of the invention;

FIG. 5B is a software flow diagram for processing payments related to a purchase using a payment network according to an embodiment of the invention;

FIG. 5C is a software flow diagram for providing product and coupon suggestions for product purchases according to an embodiment of the invention;

FIG. 5D is a software flow diagram for securing the payment network and providing administrative access to consumer user accounts according to an embodiment of the invention;

FIG. 6A is a software flow diagram for scanning a code according to an embodiment of the invention;

FIG. 6B is a software flow diagram for displaying a cart, coupons, discounts, and merchants according to an embodiment of the invention;

FIG. 6C is a software flow diagram for making a purchase from an electronic cart according to an embodiment of the invention;

FIG. 7 is a system database diagram for data stored in the memory of purchasing server according to an embodiment of the invention;

FIG. 8A is a graphical user interface (“GUI”) displaying a shopping cart according to an embodiment of the present invention;

FIG. 8B is a GUI displaying a shopping cart according to an embodiment of the invention;

FIG. 8C is a GUI displaying a shopping cart according to an embodiment of the invention;

FIG. 9 illustrates, in block diagram form, an exemplary system to authenticate a transaction between a client device and a server using a scannable code; and

FIG. 10 is a flow chart illustrating an exemplary method of authenticating a transaction between a client device and a server using a scannable code.

### DETAILED DESCRIPTION

To address the need set forth above, according to one aspect, the invention includes a communications network interface, e.g., a web server and firewall, for interacting with a plurality of users, a database for storing user account data, merchant data, and credit card data, and purchasing server for implementing the functionality of some embodiments of the instant invention.

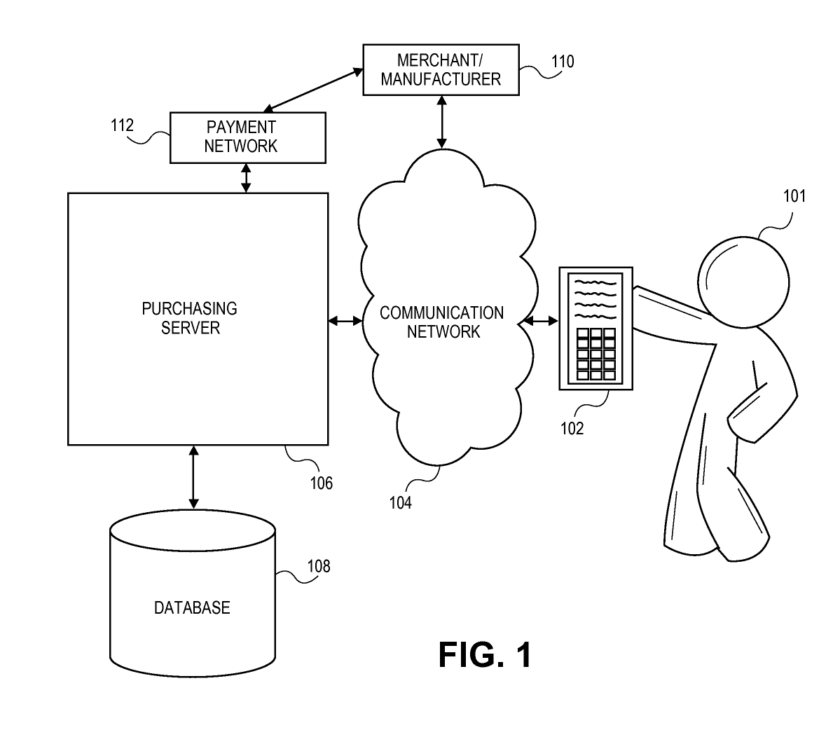

More specifically, as can be seen in FIG. 1, the system 100 of the instant invention includes mobile device 102 associated with a consumer user 101, a communications network 104, a purchasing server 106 connected to a database 108; a merchant or manufacturer computer 110; and a payment network 112. The merchant or manufacturer computer 110 can be any computing device e.g. a desktop, laptop, PDA, smartphone, computer tablet, networked computer display, computer server, as well as any other electronic device capable of connecting to the communications network 104 and receiving data from same to enable system interaction with a merchant or manufacturer (not shown) to e.g., receive payment for merchandise, upload coupons and discounts, receiving metrics concerning consumer user purchasing habits, etc. As one skilled in the art will also appreciate, the payment network 112 may be any traditional payment network, e.g., Visa®, MasterCard®, Discover®, etc., and may be networked with the purchasing server 106 as e.g., a VPN.

Though in a preferred embodiment, mobile device 102 is a smartphone, mobile device 102 is not limited to a smartphone, and can be any type of computing device, e.g. a laptop, PDA, computer tablet, as well as any other electronic device capable of scanning a code on a product, connecting to the communications network 104 and receiving data from same to enable system interaction with user 10. As such, the mobile device 102 is connected to the purchasing server 106 via communications network 104, which may be a single communications network or comprised of several different communications networks. The communications network 104 can be a combination of a public or private network, which can include e.g., any combination of the internet and intranet systems, that allow a plurality of system users to access the purchasing server 106. For example, communications network 104 can connect all of the system components using the internet, a local area network (“LAN”), e.g., Ethernet or WI-FI, or wide area network (“WAN”), e.g., LAN to LAN via internet tunneling, or a combination thereof, and using electrical cable e.g., HomePNA or power line communication, optical fiber, and radio waves, e.g., wireless LAN, to transmit data. As one skilled in the art will appreciate, in some embodiments, mobile device 102 may be connected to the communications network using a wireless LAN, but other users may be to the purchasing server 106 via a wired connect to the internet to, e.g., to set up an account from a desktop or laptop computer. In other instances, a consumer user may connect to the purchasing server 106 using, e.g., wireless LAN and the internet to set up an account. Moreover, the term “communications network” is not limited to a single communications network system, but may also refer to several separate, individual communications networks used to connect the mobile device 102 to purchasing server 106. Accordingly, though each of the mobile device 102 and purchasing server 106 are depicted as connected to a single communications network, such as the internet, an implementation of the communications network 104 using a combination of communications networks is within the scope of the invention.

As one skilled in the art will appreciate, the communications network interfaces with purchasing server 106, preferably via a firewall (not shown) and web server (not shown) to provide a secure access point for consumer users 101 and to prevent consumer users 101 from accessing the various protected databases in the system. In some embodiments, the firewall may be a network layer firewall i.e., packet filters, application level firewalls, or proxy servers. In other words, in some embodiments, a packet filter firewall can be used to block traffic from particular source IP addresses, source ports, destination IP addresses or ports, or destination service like www or FTP, though a packet filter in this instance would most likely block certain source IP addresses. In other embodiments, an application layer firewall may be used to intercept all packets traveling to or from the system, and may be used to prevent certain users, i.e., users restricted or blocked from system access, from accessing the system. Still, in other embodiments, a proxy server may act as a firewall by responding to some input packets and blocking other packets.

Returning to the figures, database 108 communicates with and uploads data to the mobile device 102 via the purchasing server 106 and communications network 104. As such, database 108 may be, for example, one or more computers, file servers or database servers implemented as network attached storage (NAS), storage area networks (SAN), or direct access storage (DAS), or any combination thereof or of other systems, comprising, e.g., multiple hard disk drives. In some embodiments, the file servers or database servers defining the database 108 may also allow various merchant/manufacturer computers to directly access, and display data stored thereon. Moreover, each of these file servers or database servers may allow consumer users, merchant users or manufacturer users to upload data to the database. For example, a consumer user may upload a username, password, address, credit card information, shipping address information, etc., and a merchant user may upload address data, product price data, discount data, etc., to be stored in, e.g., separate file servers or the same file server, in a plurality of databases, tables, or fields in separate portions of the file server memory. Accordingly, as is known in the art, the computer-implementing database 108 may have stored thereon database management system, e.g., a set of software programs that controls the organization, storage, management, and retrieval of data in the databases. As one skilled in the art will appreciate, in some embodiments, database 108 may be stored in the purchasing server memory (to be discussed below). As one skilled in the art will also appreciate, though database 108 is depicted connected to, or as a part of, the purchasing server 106, not the communications network 104, the database 108 may be, e.g., remote storage or connected to the purchasing server 106 via a privately networked system.

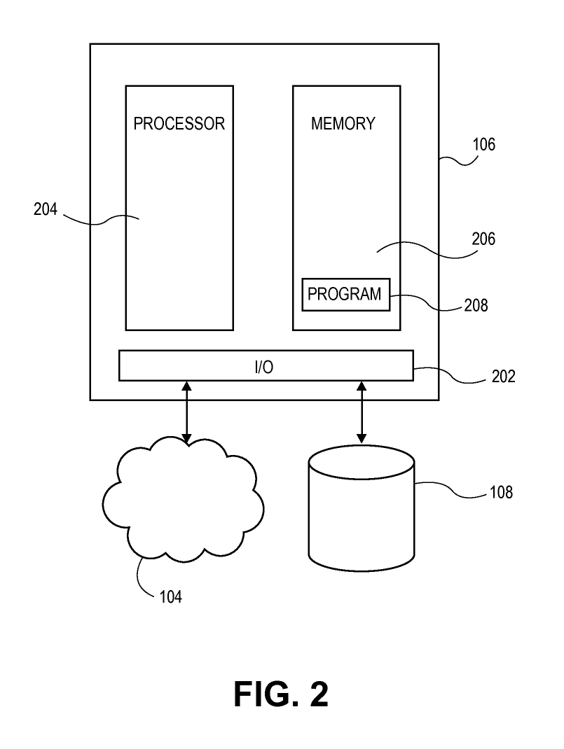

Purchasing server 106 will now be described with reference to FIG. 2. As one skilled in the art will appreciate, purchasing server 106 can be any type of computer, e.g., an application server, or a plurality of computers, comprising a memory 206, a program product 208, a processor 204 and an input/output device (“I/O device”) 202. I/O device 202 connects the purchasing server 106 to a signal from the communications network 104, and can be any I/O device including, but not limited to a network card/controller connected by a PCI bus to the motherboard, or hardware built into the motherboard to connect the purchasing server 106 to various file servers or database servers implementing database 108.

As can be seen, the I/O device 202 is connected to the processor 204. Processor 204 is the “brains” of the purchasing server 106, and as such executes program product 208 and works in conjunction with the I/O device 202 to direct data to memory 206 and to send data from memory 206 to the various file servers and communications network. Processor 204 can be, e.g., any commercially available processor, or plurality of processors, adapted for use in purchasing server 106, e.g., Intel® Xeon® multicore processors, Intel® micro-architecture Nehalem, AMD Opteron™ multicore processors, etc. As one skilled in the art will appreciate, processor 204 may also include components that allow the purchasing server 106 to be connected to a display [not shown] and keyboard that would allow, for example, an administrative user direct access to the processor 204 and memory 206.

Memory 206 may store the algorithms forming the computer instructions of the instant invention and data, and such memory 206 may consist of both non-volatile memory, e.g., hard disks, flash memory, optical disks, and the like, and volatile memory, e.g., SRAM, DRAM, SDRAM, etc., as required by embodiments of the instant invention. As one skilled in the art will appreciate, though memory 206 is depicted on, e.g., the motherboard, of the purchasing server 106, memory 206 may also be a separate component or device, e.g., FLASH memory or other storage, connected to the purchasing server 106.

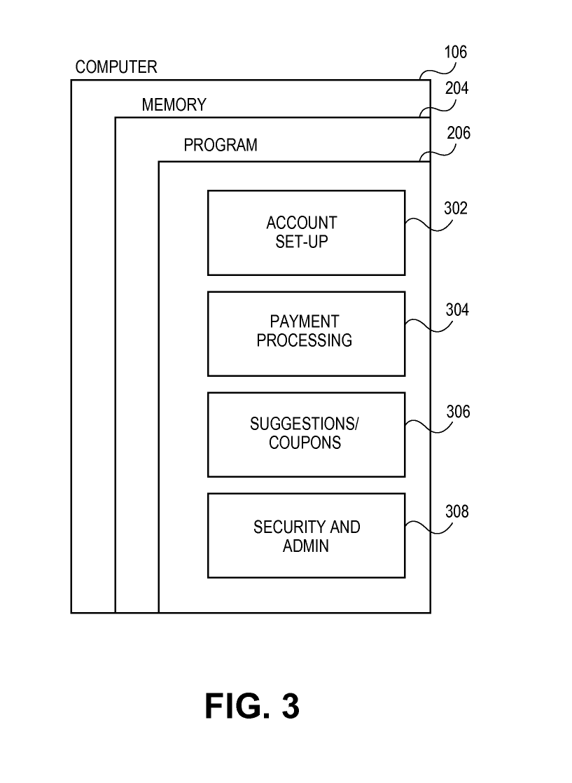

As shown in FIGS. 2 and 3, an embodiment for computer instructions implementing some of the functionality of the instant invention is stored in memory 206, e.g., as a plurality of programming modules. The programming modules for the program product include an account set-up module 302, a payment processing module 304, a suggestions/coupon module 306, and a security/administration module 308. The account set-up module 302 includes, e.g., instructions for setting up a user account, including, e.g., a username, password, credit card information, merchant preferences, billing address, and one or more shipping addresses. As one skilled in the art will appreciate, the account set-up module 302 may include options for the types of coupons, discounts, or other merchant information the user wishes to receive. For example, the user may only wish to see merchant discounts for other merchants if the discounts exceed a certain percentage of the price for the item in the user's cart, in other instances, a consumer user may only want to see discount or merchant information from a preferred set of vendors. Accordingly, the account set-up module can include prompts that enable to user to set such preferences. The account set-up module 302 may also include a link to a mobile device application (discussed below) for the user to download to their device. Alternatively, in some embodiments, the user may initiate the application and program set-up through an application store or database of applications for purchase.

The payment processing module 304 can include instructions for processing a payment from the user to the merchant. As such, the payment processing module 304 may operate in conjunction with, e.g., a traditional payment network (not shown) such as VISA® or MasterCard® to process payment to the merchant. In some embodiments, the user will be charged for the use of the payment network, e.g., 50¢; in other embodiments, the payment processing computer or the payment network may deduct from a merchant payment for the item the amount it is charged to use the payment network (not shown). The payment processing module 304 may also include instructions for charging the consumer user for the use of the system to process the transaction, e.g., 10% of the savings value is credited to the payment service. In such embodiments, for example, the consumer user may have received a 10% total discount for cart purchases, then the system would be credited a payment of 10% of the savings or 1% of the total sales value. In other embodiments, the payment processing module may include instructions where merchants pay the system to have discounts and suggestions presented to the consumer user. For example, merchants may pay to have products or stores appear higher in a suggestion ranking than other merchants do.

Returning to FIG. 3, the suggestions/coupon module 306 may include, e.g., instructions to search and select discounts for the items in the consumer user's shopping cart. In some embodiments, the suggestion/coupon module can be initiated when the user requests coupons, merchant information or product suggestions from the mobile device 102. In other embodiments, the suggestion/coupon module can be initiated whenever the user asks to purchase a product. In each case, in some embodiments, if the purchasing server 106 determines a coupon or a discount is available, the purchasing server sends all available coupons or discounts to the user for the user to select a coupon or discount to apply to the user's purchase. If the user has requested a list of merchants selling an item in the user's shopping cart, the purchasing server in some embodiments send all preferred merchants selling the item to the user. In other embodiments, the purchasing server may send only merchants that list the item at a lower price, e.g., with shipping costs if necessary, and/or send a list of merchants that have a lower price by a user specified percentage, e.g., 10%, so the user can filter out less attractive offers.

Finally, the security/administration module 308 ensures the connection between the mobile device 102 and the purchasing server is secure. As such, the security/administration module 308 may include instructions to send an “electronic handshake”, e.g., a unique code to the mobile device that must be transmitted back to the purchasing computer before a payment is processed, and/or use GPS to locate and verify the mobile device placing the purchase is associated with the consumer user.

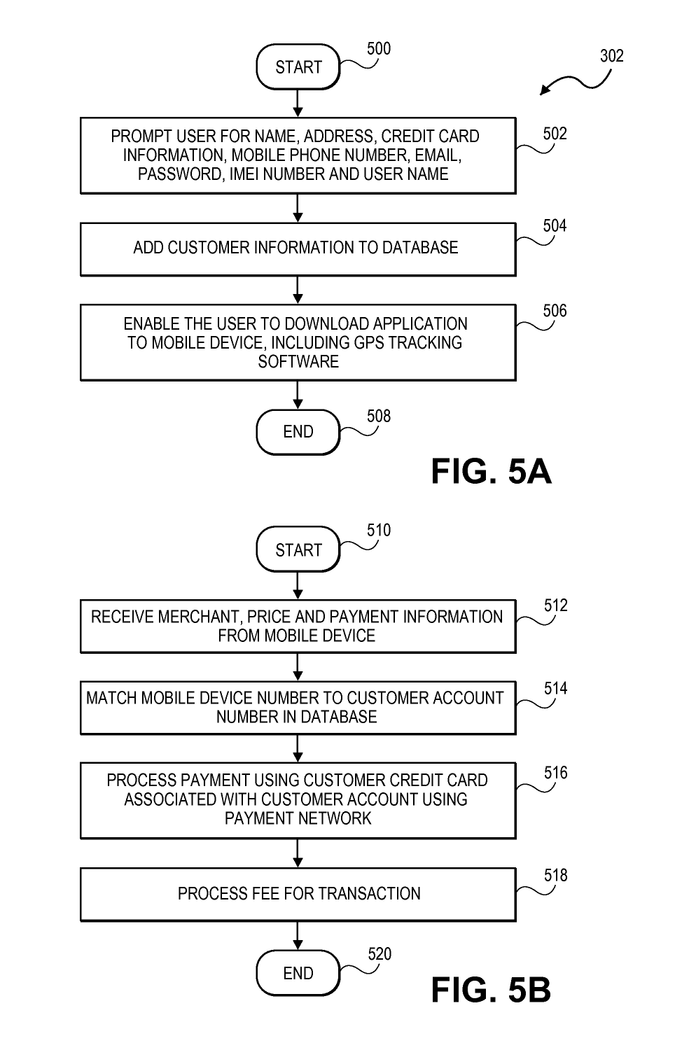

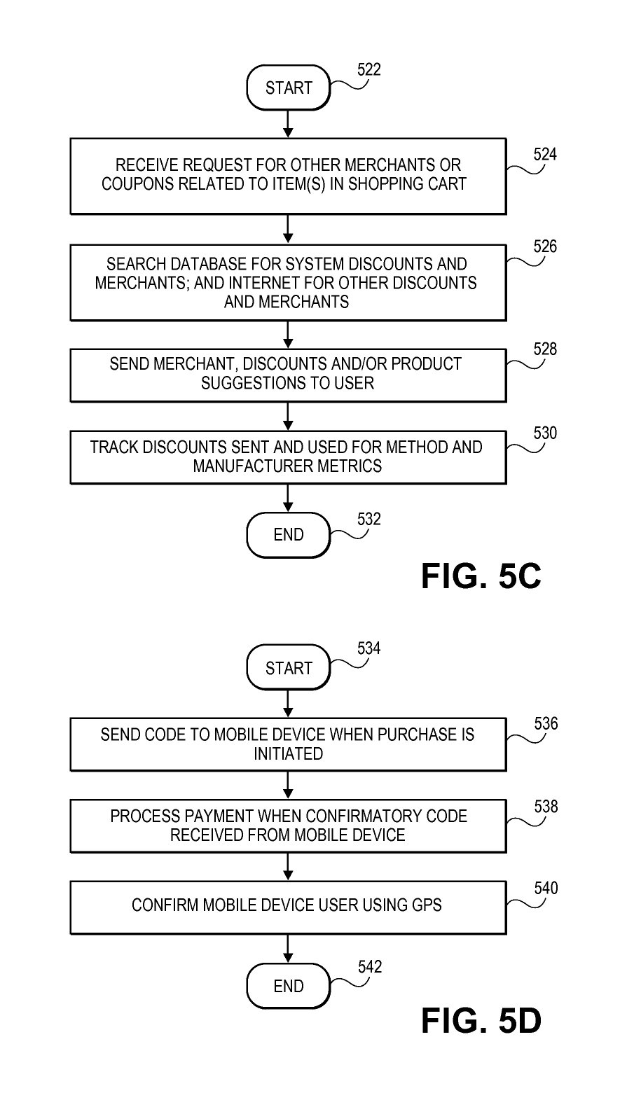

An exemplary embodiment of the computer program flow for processes implementing the account set-up module 302, the payment processing module 304, the suggestions/coupon module 306 and security/administration module 308 will now be discussed with reference to FIGS. 5A-5D. As one skilled in the art will appreciate, though the flow diagrams are shown as implemented in a serial configuration, such flow is for simplicity only and should be understood to include various loops and processes that may be run concurrently and/or used to implement each of the instructions, or a plurality of the instruction, therein.

To implement the account set-up module 302, the process starts at step 500. At step 502, the consumer user is prompted for, e.g., one or more of a name, address, credit card information, mobile phone number, email address, password, IMEI number, username, etc. In some embodiments, the consumer user may also be prompted to provide preferred merchant names, e.g., GAP®, Amazon®, Target®, Best Buy®, etc., preferred product brands, e.g., Proctor & Gamble®, Sony®, Nike®, etc., and preferred minimum discount amounts, e.g., 10%. As one skilled in the art will appreciate, the merchant names, product brands and discounts can be used to tailor coupons, competing merchant data, and product suggestions to the consumer user. For example, a consumer user that prefers Proctor & Gamble products could have a suggestion for a new cleaning product that has a 10% off coupon associated with it when the consumer user decides to purchase a cart that includes a cleaning product. As one skilled in the art will also appreciate, the consumer user account set-up prompt can be revisited by a registered consumer user to change preferences, e.g., password, credit card information, and merchant, product and discount preferences, etc.

In some embodiments, the user can be a merchant user, a consumer user or a product manufacturer. In such embodiments, e.g., the merchant user may upload a database of items that are discounted in its store, or storewide discounts; and the product manufacturer may download coupons and other discounts. The merchants and manufacturers, in some embodiments, may also be able to connect to information regarding the coupons and discounts used by consumer users, and track the number of times competing merchants and products were sold, and accordingly can set-up a consumer user analytic page that includes such information as coupon downloads, product preferences, sales completed based on discount, carts abandoned for other brands, etc. Once such a user provides account information to the account set-up prompt, the consumer user information is added to the database in step 504. As one skilled in the art will appreciate, the user data can be stored in separate portions of the database depending on the type of user, e.g., a merchant user or manufacturer user information would be stored in separate tables, databases, etc. In step 506, in some embodiments, the user is able to download an application to a user computer or mobile device, e.g., a consumer user can download an application to its mobile device, or a merchant/manufacturer user can download a desktop or mobile application. As one skilled in the art will appreciate, in some embodiments, the manufacturer and merchant can download a software application to its computer, and in other embodiments, the merchant or manufacturer can access the purchasing server through a web interface. In step 508, the process ends.

Turning to FIG. 5B, the payment processing module will be described in more detail. The process starts in step 510, and in step 512, the purchasing server receives, for example, merchant, product, price and payment information from the mobile device. As one skilled in the art will appreciate, the merchant information could be a merchant identifier code, e.g., an alphanumeric code, for use in a traditional payment network, and not other merchant identifier information such as the merchant name and address. In addition, in some embodiments, the product information may be a numeric product identifier, and in other embodiments, the consumer user may be able to enter manually a new credit card into the system or transmit a credit card stored in the mobile device for use by the purchasing server. Once the purchasing server has received merchant, price and/or product information, the mobile device number sending the same is matched to a consumer user account number in step 514. The consumer user account number is unique for each consumer user, and may be only known to the purchasing server so that consumer user information is secure. Once the consumer user number is matched to the consumer user account, in step 516, the credit card associated with the consumer user is charged using, for example, a traditional payment network. As one skilled in the art will appreciate, the payment network is a pre-existing network to process credit transactions, e.g., Visa®, MasterCard®, Discover®, etc. As such, in some embodiments, the purchasing server may determine whether the merchant is associated with the payment network used by the consumer user's credit card, e.g., whether or not the merchant takes Visa®. In step 518, the consumer user may be charged a convenience fee for the use of the service. Alternatively, in some embodiments, the merchant may be accessed a fee for using the service. In step 520, the process ends.

Turning to FIG. 5C, the suggestion/coupon module 306 will be described. The process starts at step 522. In step 524, the purchasing server receives a request for other merchant or coupons related to the item(s) in the consumer user's shopping cart. The purchasing server searches the database for system discounts and merchants, and, e.g., the internet for other discounts and merchants in response to the request in step 526. In step 528, the merchant sends the merchant, discount and product suggestions to the consumer user. As one skilled in the art will understand, and as described above, the purchasing server may tailor the merchants, suggestions and discounts to the user preferences saved by the consumer user so the consumer user only receives the suggestions, merchants and discounts it prefers. In step 530, the purchasing server tracks the discounts, suggestions and merchant information sent to produce merchant and manufacturer metrics. For example, merchant and manufacturer users may pay for discounts and product suggestions to be included in the database so it can track the popularity of its products, or induce the consumer user to try new brands or product items. In such embodiments, the system may produce consumer metrics so that the merchant and manufacturer users can access the volume of sales and types of consumers using their system and buying their products. The process ends in step 532.

Turning now to FIG. 5D, the security/administrative module 308 will be described. The process starts in step 534, and in step 536, a unique code is sent to the consumer user's mobile device when the consumer user requests a checkout, and the purchasing server clears the transaction. Once the consumer user confirms the unique code, e.g., by sending back to the purchasing server the unique code in a confirmatory message, the purchasing server process payment for the items in the cart in step 538. In some embodiments, if the code transmitted back to the purchasing server is not a match, the purchasing server will send the mobile device an error code. In other embodiments, any time the purchasing server is unable to maintain a connection with the mobile device, e.g., to send a payment confirmation, an error message will be transmitted to the mobile device indicating that a purchase was not processed. In such instances, the purchasing server may cancel the transaction for all transactions that are processed with an error, while in other embodiments, the purchasing server may temporarily store a partial transaction to determine whether the mobile device can be reconnected to the network. In embodiments where the partial transaction is stored temporarily, the purchasing server may attempt to reconfirm the purchase by transmitting another code. In some such embodiments, the purchasing server may only attempt to complete the transaction by transmitting a new code a limited number of times, e.g., three. In step 540, the purchasing server confirms payment using the mobile device's GPS signal. As one skilled in the art will appreciate, steps 538 and 540 can be run concurrently or alternatively in some embodiments. In step 542, the process ends.

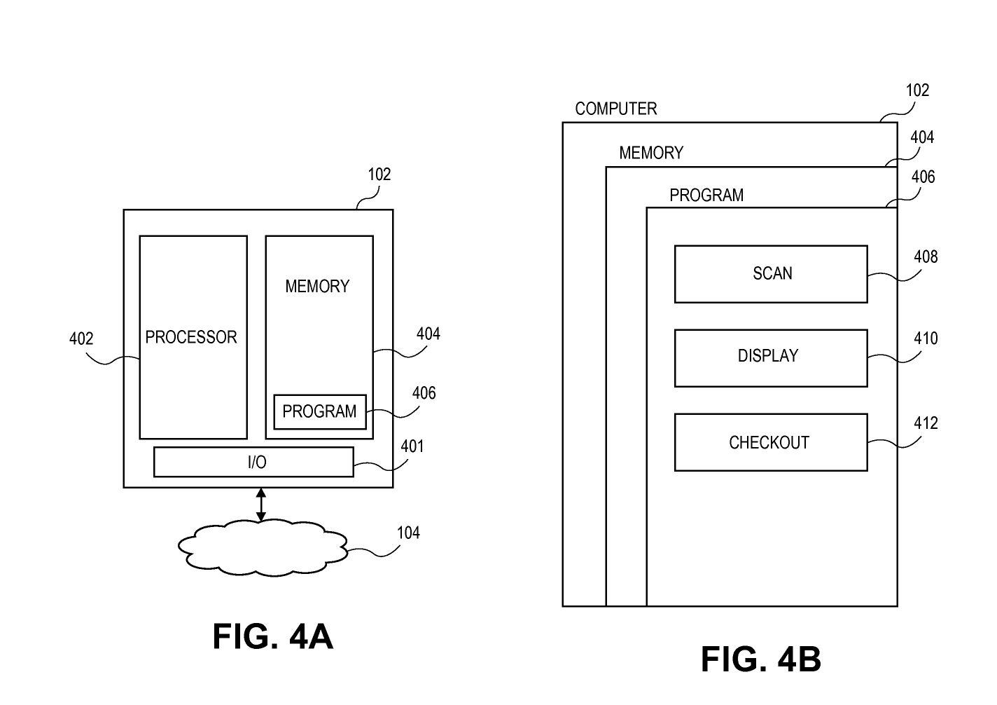

Mobile device 102 will now be described with reference to FIG. 4A. As one skilled in the art will appreciate, mobile device 102 can be any type of computer, e.g., an application server, or a plurality of computers, comprising a memory 404, a program product 406, a processor 402 and an input/output device (“I/O device”) 401. I/O device 401 connects the mobile device 102 to a signal from the communications network 104, and can be any I/O device including, but not limited to a network card/controller connected by a PCI bus to the motherboard.

As can be seen, the I/O device 401 is connected to the processor 402. Processor 402 is the “brains” of the mobile device 102, and as such executes program product 406 and works in conjunction with the I/O device 401 to direct data to memory 404 and to send data from memory 404 to the various file servers and communications network. Processor 402 can be, e.g., any commercially available processor for mobile devices, e.g., Intel® Core 15 or AMD Turion microprocessors. As one skilled in the art will appreciate, processor 402 may also include components that allow the mobile device 102 to be connected to a computer via, e.g. a USB port.

Memory 404 may store the algorithms forming the computer instructions for an application (“app”) stored therein to enable system functionality, and such memory 404 may consist of e.g., internal FLASH memory, which may be NAND and/or NOR type, as required by embodiments of the instant invention. As one skilled in the art will appreciate, though memory 206 is depicted on, e.g., the motherboard, of the mobile device 102, memory 404 may also be a separate component or device, e.g., additional FLASH memory, SD card, or other storage, connected to the mobile device 102.

As shown in FIGS. 4A and 4B, an embodiment for computer program 406 implementing some of the functionality of the instant invention is stored in memory 404, e.g., as a plurality of programming modules. The programming modules for the program product 406 include a scan module 408; a display module 410; and a checkout module 412. As one skilled in the art will appreciate, the scan module 408, display module 410 and checkout module 412 may be uploaded to the mobile device as an application (“app”) for the mobile device for use in conjunction with the website associated with the purchasing server 106.

The scan module 408, for example, enables the consumer user to scan a product code, such as an audio signal, Quick Response (QR) code, or bar code. In a preferred embodiment, the mobile device scans a QR code, which can be used to store the product name, price, manufacturer, merchant, discounts etc. As one skilled in the art will appreciate, the QR code can be supplied on the product packaging, printed on labels that are adhered to the product, or appear on a display screen generated by a website. As such, the app downloaded to the consumer user's mobile device includes software that enables the mobile device to read QR codes, e.g., using the pixels associated with the digital camera to determine the aligning squares, etc., as known in the art. In other embodiments, the code can represent a bundle of products and a combined price for these products, which will also be called a “product price.” Once the product code is scanned, the mobile device stores information related to the product, such as, but not limited to, the product name, product price, and merchant into memory. The display module 410 can read the product name, product price and merchant name from memory and format the information into a mobile device cart display, e.g., showing a list of products the consumer user wishes to purchase. In some embodiments, the mobile device may use GPS and merchant data to determine the sales tax for the product, and add such tax to the purchase price so the consumer user can see the true cost of the product for purchase. In some embodiments, the mobile device may include any discounts that are available for the product, e.g., if the QR code indicates the product is 40% off. In other embodiments, the consumer user may indicate a discount amount to determine a product discount on the display, e.g., when a merchant has certain goods marked 40% off, where the discount is reflected at the register. In other embodiments, the product added to the cart may be transmitted to the purchasing server 106, which in turn sends applicable discounts to the mobile device. In any such instance, the display module can format the cart display with the applicable price, including tax and discounts. The display module also may allow the consumer user to initiate a checkout sequence, such as that executed by checkout module 412. Checkout module 412 transmits the consumer user's cart to the purchasing server (as discussed above) and receives payment confirmation or a numeric code to re-transmit to the purchasing server at the consumer user's request. As one skilled in the art will recognize, the checkout module and display module may be combined in some embodiments, e.g., the checkout module can initiate the checkout sequence, etc.

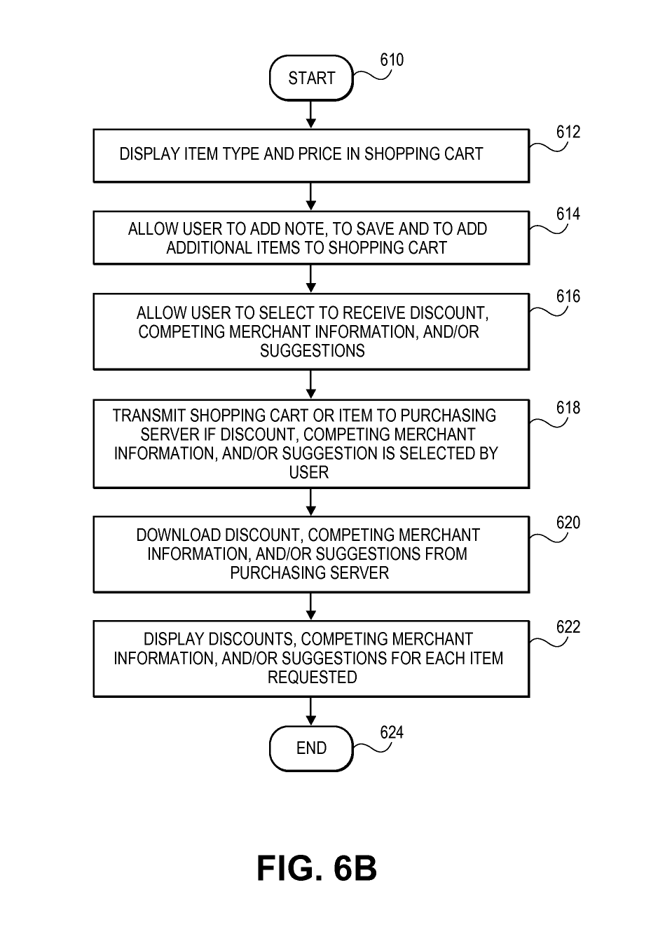

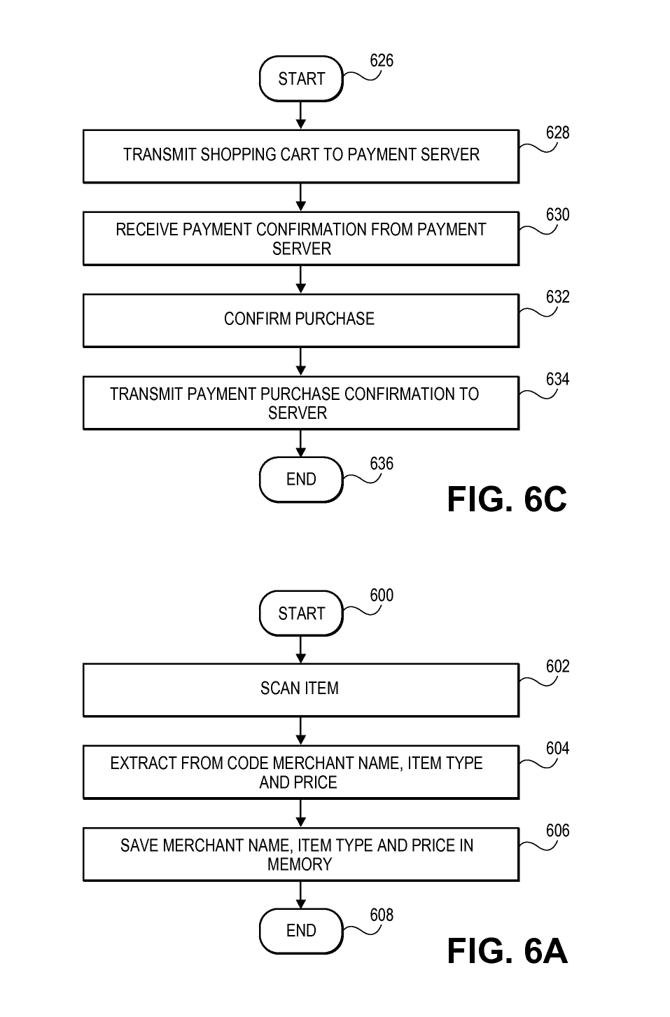

An exemplary embodiment of the computer program flow for processes implementing the scan module 408, the display module 410, and the checkout module 412 will now be discussed with reference to FIGS. 6A-6C. As one skilled in the art will appreciate, though the flow diagrams are shown as implemented in a serial configuration, such flow is for simplicity only and should be understood to include various loops and processes that may be run concurrently and/or used to implement each of the instructions, or a plurality of the instructions, therein.

Turning to FIG. 6A, the module starts in step 600. At step 602, the consumer user scans an item for purchase. In such instances, the consumer user can initiate the app on their mobile device and scan via a screen showing the product code. Once the product code has been scanned, in step 604, the computer program decodes the product code to determine the merchant name, product and product price. As those skilled in the art will recognize, a QR code is decoded by the app using known methods, e.g., locating, in a digital image of the code, the three distinctive squares at the corners of the image; normalizing image size, orientation, and angle of viewing, with the aid of a smaller square near the fourth corner; converting the small dots in the code to binary numbers; and checking the validity of the conversion with an error-correcting code. Once, in some embodiments, the product, product price and merchant may be determined, this data is saved in the mobile device memory in step 606. In some embodiments, the QR code includes a unique identifier for the purchasing server database, and as such, one or more of the merchant name, product or product price may not be decoded in lieu of the unique identifier. The process end in step 608.

Turning now to FIG. 6B, the display module 410 starts in step 610. In step 612, the product and price are retrieved from memory and displayed to the consumer user, e.g., in an electronic shopping cart. As one skilled in the art will recognize, the shopping cart may not display the merchant associated with the product to the consumer user in some embodiments. Once the shopping cart is displayed to the consumer user, the display enables the consumer user to add a note or additional items to the shopping cart in step 614. In some embodiments, the consumer user may add a note to each item, e.g., notation of who the product is for, the discount price for the product, etc. In other embodiments, the consumer user may add a note to an entire cart of products to, e.g., save a preferred shopping list. As one skilled in the art will recognize, a shopping cart in such embodiments may also be sent to other system users, e.g., a spouse, relative or friend, with the note so that person can purchase similar items in the future, not duplicate a shopping trip, or give opinions or advice regarding the purchase. For example, a consumer user may add a note to a cart including milk, bread, cheese, beer, green beans, and potato chips from a shopping trip, and transmit the same to a spouse so duplicate items are not purchased. In another example, a consumer user may save a note such as “how does this look?” to a shopping cart including, e.g., electronics, and transmit same to a friend to get an opinion on same. Accordingly, though not all variations are described herein, all may be considered part of this disclosure. As previously mentioned, the app may include instructions that allow the consumer user to add more items to the shopping cart, e.g., scan more QR codes. In such embodiments, the consumer user may select to add additional items to the shopping thereby initiating the mobile device's camera. In other embodiments, the consumer user may select to use credit card information stored, e.g., in the mobile device to conduct any transaction. In such an embodiment, the consumer user may select from a plurality of credit cards stored on the phone, or may choose to enter new credit card information into a display prompt located in the display. As one skilled in the art will recognize, the app on the mobile device may also include software to encrypt any credit card information stored in memory, e.g., in case the mobile device is stolen or lost.

Returning to FIG. 6B, in step 616, the display screen may also allow the consumer user to determine whether or not they would like to receive discounts, competing merchant information and/or item suggestions for products displayed. In some embodiments, the consumer user may select each product for which the consumer user would like to have a discount, competing merchant information and/or item suggestions. In other embodiments, the consumer user may select to receive discounts, competing merchant information and/or item suggestions on their entire cart, and in other embodiments, the consumer user may select whether it wants to see discounts, competing merchant information or item suggestions for each item or the entire shopping cart. After the consumer user has selected to receive discounts, the shopping cart is sent to the purchasing server in step 618. In step 620, the mobile device downloads any available discounts, competing merchant information and/or item suggestions for the products selected by the consumer user to receive same, and in step 622 displays discounts, competing merchant information and/or item suggestions to the consumer user. As such, the consumer user can select which of the discounts, competing merchant information and/or item suggestions to apply to the shopping cart. For example, the consumer user may select to purchase an item at a suggested merchant, so the application creates a new shopping cart with the suggested merchant and removes the item from the original shopping cart. In such embodiments, the shopping carts may appear on the same display, i.e., one purchasing display may facilitate a transaction at multiple merchants. In other examples, the consumer may select to add a different product having a bigger discount associated, and the mobile device may remove the original item from the shopping cart. In some embodiments, the mobile device may instruct the consumer user to scan the code for the new item to complete the transaction for the new item, e.g., to prevent the consumer user from applying a discount for the suggested item to the original item. In step 624, the process ends.

As one skilled in the art will appreciate, other computer program steps may be added to those described above to implement other features, e.g., a prompt may be displayed for the consumer to login, e.g., provide a user login id and password, and a prompt may be displayed so the consumer user can determine which products they purchase frequently, e.g., so those products are automatically provided to the consumer user for purchase at pre-determined intervals and/or a purchase schedule for the products is saved in the consumer user's mobile device calendar. For example, the consumer user may purchase shampoo, soap and paper towels every six weeks, in which case the application would allow the consumer user to add such a shopping list to the consumer user's mobile device calendar with a link to the shopping cart. Accordingly, though not all such instructions are described herein, all variations in implementation should be considered within the scope of the invention.

Turning to FIG. 6C, the processes comprising the checkout module start in step 626. The steps include transmitting the shopping cart to the payment server in step 628, e.g., when the consumer selects a checkout tab on the shopping cart display; receiving payment confirmation from the payment server in step 630; confirming the purchase in step 632, e.g., by sending a confirmation code to the purchasing server in response to the consumer user selecting to finalize purchase; and transmitting the payment purchase confirmation to server in step 634. The process ends in step 636. In some embodiments, if the code transmitted back to the purchasing server is not a match, the purchasing server will send the mobile device an error code. In other embodiments, any time the purchasing server is unable to maintain a connection with the mobile device, e.g., to send a payment confirmation, an error message is displayed on the mobile device that a purchase was not processed. In such instances, the purchasing server may cancel the transaction as discussed above. As one skilled in the art will appreciate, the confirmation of the purchase step and transmitting the confirmation to the purchasing server may facilitate an electronic handshake to confirm the transaction. In other embodiments, however, the GPS system of the mobile device may be used to confirm a purchase as discussed above. Moreover, in some embodiments where the user scans a code rendered in a web browser (for example, a QR code), when the payment is processed by the purchasing server, the purchasing server or the mobile device may transmit a signal to the browser that rendered the code to update the browser's current page or forward the user to a receipt page indicating that the transaction has been processed. In one embodiment this is achieved by javascript code running in the user's web browser that renders the QR code, which listens on a unique web socket. An identifier specific to that browser's session, such as a session id, can be embedded in the code and subsequently used by the processing server or mobile device to look up the appropriate socket and send a message to the browser. In a specific example relating to a purchase from a website, the user loads the checkout page on a first computer. The server generates a QR code that includes a session id, a price for the product, and the merchant information. The user uses his mobile device to scan the QR code. The user's mobile device can then transmit the information obtained from the QR code (i.e., including the price and merchant information), as well as credit card information, customer information, and GPS information (for fraud protection) to the server. After verification, the server can tell the browser on the first computer that the transaction is successful by using the session id. The merchant can allow one transaction per id. Accordingly, though not all such instructions are described herein, all variations in implementation should be considered within the scope of the invention.

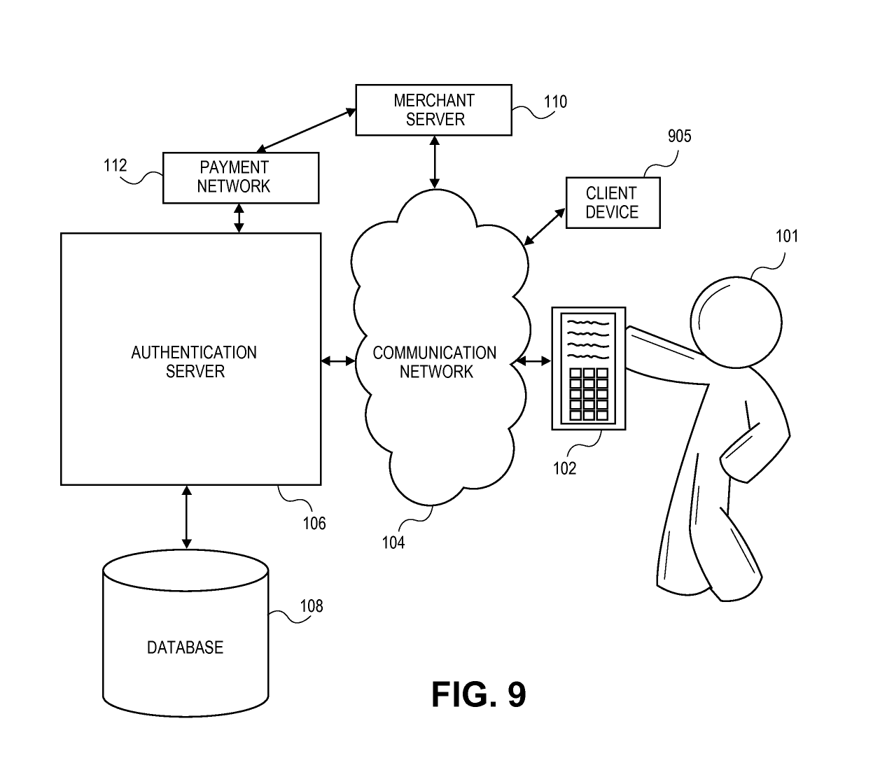

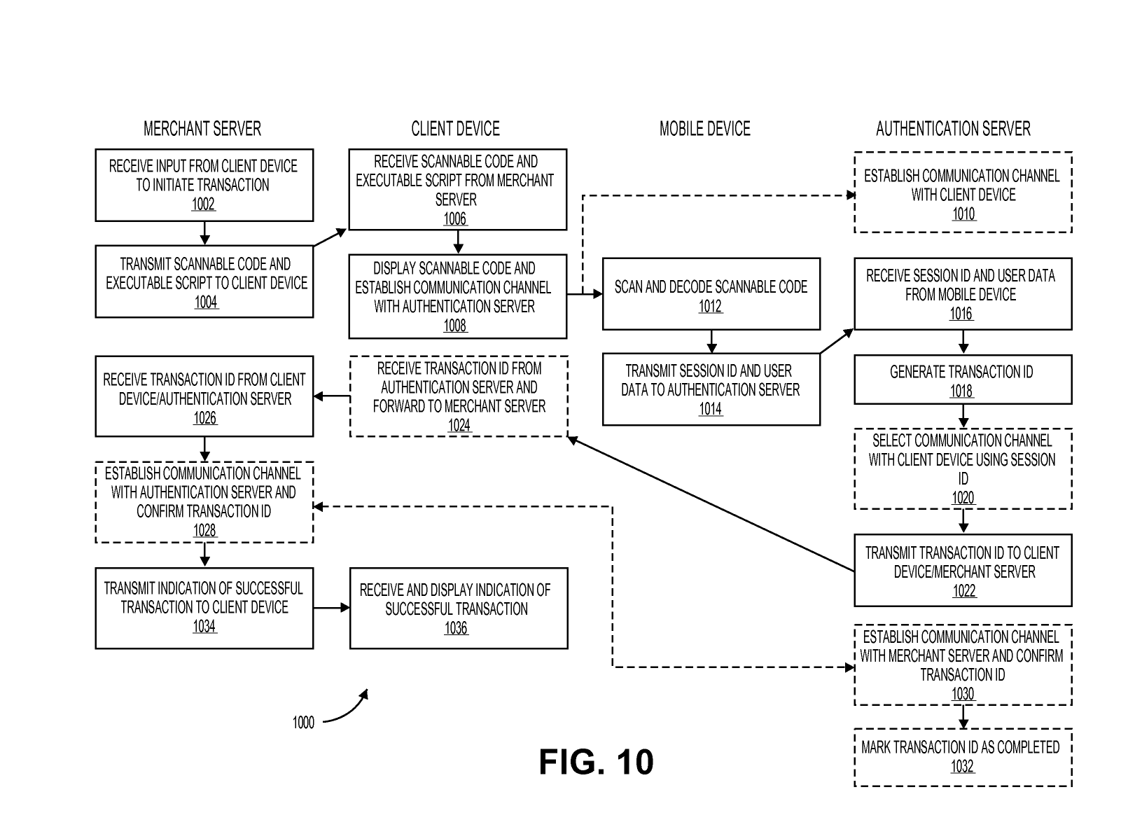

For example, FIG. 9 illustrates, in block diagram form, an exemplary system to authenticate a transaction between a client device and a server using a scannable code. The system illustrated in FIG. 9 includes common features as those described with reference to FIG. 1. Additional features will be described with reference to FIG. 10.

FIG. 10 is a flow chart illustrating an exemplary method 1000 of authenticating a transaction between a client device and a server using a scannable code. While method 1000 is described from a system perspective, portions of method 1000 may be performed separately or omitted. For example, in one embodiment, merchant server 110 and authentication server 106 may be combined into a single server, thereby eliminating one or more blocks of method 1000. Additionally, some features are illustrated in broken line to emphasis the optional nature of those features.

Method 1000 is described with reference to actions performed by merchant server 110, client device 905, mobile device 102 (which may also be referred to as another client device), and authentication server 106. Client device 905 may be a personal computer, tablet-style device, a personal digital assistant (PDA), a cellular telephone with PDA-like functionality, a Wi-Fi based telephone, a handheld computer which includes a cellular telephone, a media player, an entertainment system, or devices which combine aspects or functions of these devices, such as a media player combined with a PDA and a cellular telephone in one device. In other embodiments, client device 905 may be a network computer, server, or an embedded processing device within another device or consumer electronic product. Similar to the description of mobile device 102 with reference to FIG. 4A, client device 905 includes a processor 402, memory 404 storing executable instructions to perform the features described herein, and I/O device 401. I/O device 401 may include a display device, or a controller to cause a display device to display data.

At block 1005, merchant server 110 receives input from client device 905 to initiate a transaction during a session between client device 905 and the merchant server 110. As used herein, a session refers to a semi-permanent interactive information interchange/dialogue between client device 905 and merchant server 110. As described above, an exemplary transaction includes payment for goods or services as initiated by a checkout process. Alternatively, a transaction may include another form of authentication between merchant server 110 and client device 905. For example, the authentication may a part of a log in process or other confirmation of the identity/permission of a user, device, program, etc.

At block 1004, the merchant server 110 transmits a scannable code to client device 905, e.g., to be displayed in a webpage via a browser. The scannable code may be a barcode, matrix barcode (e.g., a QR code), or another visual and/or audio code encoding data that be scanned by another device. The scannable code encodes a session identifier (ID) for the session between the client device 905 and merchant server 110. In one embodiment, the scannable code encodes additional data for the authentication, e.g., an amount of payment due, merchant identifier, permission/access request details, etc. At block 1004, the merchant server 110 optionally transmits an executable script, e.g., as a part of the webpage, to client device 905.

At block 1006, client device 905 receives the scannable code and, if included, the executable script from merchant server 110. At block 1008, client device 905 displays (or, if audio, plays) the scannable code. If an executable script is received, client device 905 executes the received script, causing client device 905 to establish a communication channel with authentication server 106. For example, the script may cause client device 905 to send a request to authentication server 106 to establish the communication channel according to WebSocket or a similar protocol. At block 1010, authentication server 106 responds to the request to establish the communication channel. One or both of client device 905 and authentication server 106 may associate the established communication channel with the session ID.

At block 1012, mobile device 102 scans the scannable code displayed (or played) by client device 905. For example, in response to a QR code displayed on client device 905, user 101 may use an application on mobile device 102 to scan the QR code. In response to scanning the scannable code, mobile device 102 decodes the scannable code to obtain the session ID and any other encoded data related to the transaction.

At block 1014, mobile device 102 transmits the decoded transaction data, including at least the session ID, along with user data stored by mobile device 102 to authentication server 106. Exemplary user data includes a user identifier, mobile device identifier (e.g., a data link layer/hardware address for mobile device 102), payment information (e.g., payment account information), etc.

At block 1016, authentication server 110 receives session ID, user data, and any other transaction data from mobile device 102. At block 1018, authentication server generates a transaction identifier (ID) to authentication the transaction. For example, if the transaction includes payment for goods/services, authentication server may use received payment information and payment amount to process payment via payment network 112 and generate a transaction ID representing a successful payment. Alternatively, authentication server 106 may utilize a received user identifier or device identifier to look up permissions stored in database 108 to confirm that client device 905 has permission to proceed with the transaction with merchant server 110. The generated transaction ID represents that authentication server 106 has authenticated that client device 905 may proceed with the transaction with merchant server 110.

In an embodiment in which client device 905 and authentication server 106 establish a communication channel, at block 1020, authentication server selects the established communication channel using the received session ID. For example, authentication server 106 may associate each of one or more communication channels with session ID's corresponding to the respective client device 905 that requested to establish the respective communication channel.

At block 1022, authentication server 106 transmits the transaction ID to merchant server 110. In one embodiment, the transaction ID is transmitted directly to merchant server 110 via a communication channel established between authentication server 106 and merchant server 110. Alternatively, the transaction ID is transmitted to client device 905 via the communication channel selected in block 1020.

If the transaction is transmitted to client device 905, at block 1024, client device 905 forwards the transaction ID to merchant server. For example, the executable script may cause client device 905 to forward the transaction ID to merchant server 110 in response to receipt of the transaction ID from authentication server 106.

At block 1026, merchant server 110 receives the transaction ID from authentication server 106. If merchant server 110 received the transaction ID via client device 905, at blocks 1028 and 130, merchant server 110 and authentication server 106 optionally establish a confirmation communication channel to confirm the transaction ID. For example, merchant server 110 may transmit a request to confirm the transaction ID over a secure/encrypted channel to authentication server 106. In response, authentication server 106 transmits a confirmation to merchant server 110 over the confirmation channel. In one embodiment, at block 1032, authentication server 106 marks a stored version of the transaction ID as complete to prevent the transaction ID from being used again or otherwise misused.

At block 1034, merchant server transmits an indication of a successful transaction to client device 905 in response to the (confirmed) transaction ID. At block 1036, client device 905 receives and displays the indication of successful transaction. For example, for a purchase of goods/services, the indication may include the display of a receipt or other record/confirmation of the transaction. Alternatively, for another form of authentication, the indication may be the display of secure data/resources or provide access to secure data/resources.

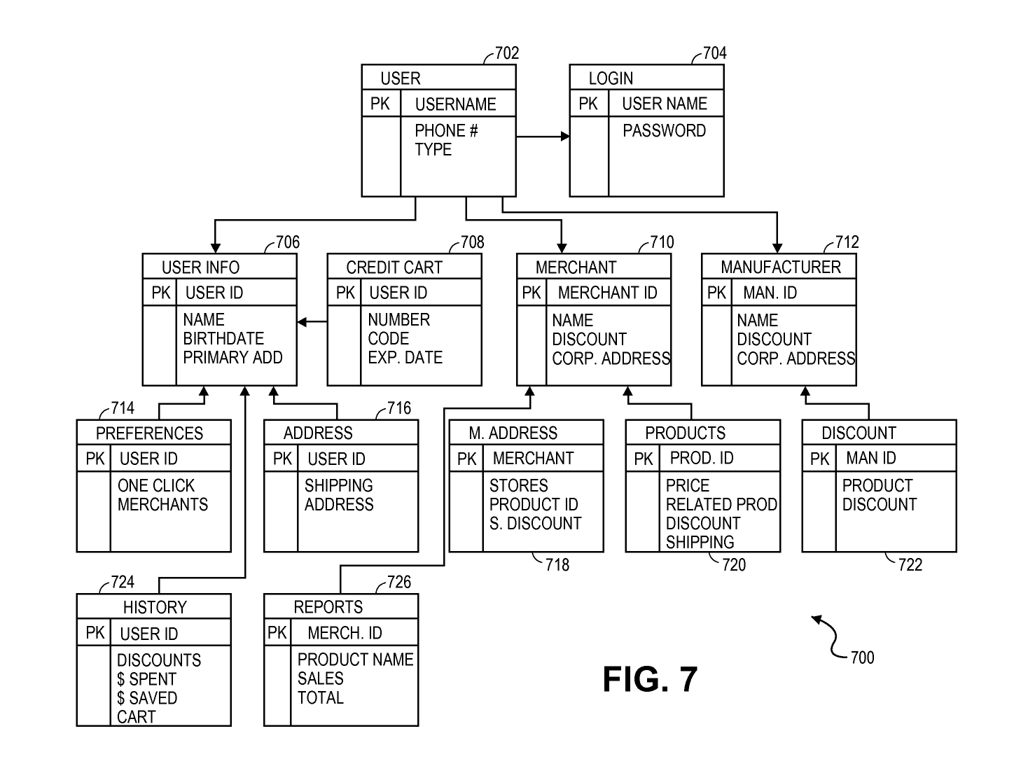

Turning to FIG. 7, an exemplary database 700, is organized into several tables for each of the steps described in FIGS. 4A-4D, including, for example, a user table 702; a login table 704; a user information table 706; a credit card table 708; a merchant table 710; a manufacturing table 712; a preferences table 714; an address table 716; a merchant address table 718; a products table 720; a discounts table 722; a history table 724 and a reports table 726. In an exemplary embodiment, user table 702 may include, e.g., a user name as the primary key, and a mobile device number and user type, e.g., consumer user, merchant user or manufacturer user, stored as separate rows in the table. For the login table 704, the primary key may be the user name, and the rows may be defined by the user password. For the consumer user information table 706, the primary key may be a user identifier (“user ID”), and the rows may be defined by the consumer user's name, birth date and primary address. For the credit card table 708, the primary key may be the user ID, and the credit card number, verification code, and expiration date may define the rows. For the merchant table 710, the primary key may be the merchant ID and the rows may be defined by the merchant name, discount, and corporate address. For the manufacturer table 712, the primary key may be the manufacturer ID, and the rows may be defined by the manufacture name, manufacturer discount, and corporate address. For the preferences table 714, the primary key may be the user ID, and the rows may be defined by indicators for “one click” purchasing, preferred merchants, preferred products, etc. For the address table 716, the primary key may be the user ID, and the rows may be defined by a shipping address; for the merchant address table 718, the primary key may be the merchant ID, and the rows may be defined by the stores; product IDs; and store discounts; the products table 720 may include a product ID as the primary key, and the rows may be defined by price, related products, discounts; and shipping charges; the discount able 722 may include the manufacturer ID as a primary key and a product ID and discount as rows; the history table 724 may include the user ID as a primary key, and discounts, money spent, money saved, cart, and notes as rows; and the reports table 726 may include the merchant ID as a primary key and a product ID, sales volume and total sales as rows.

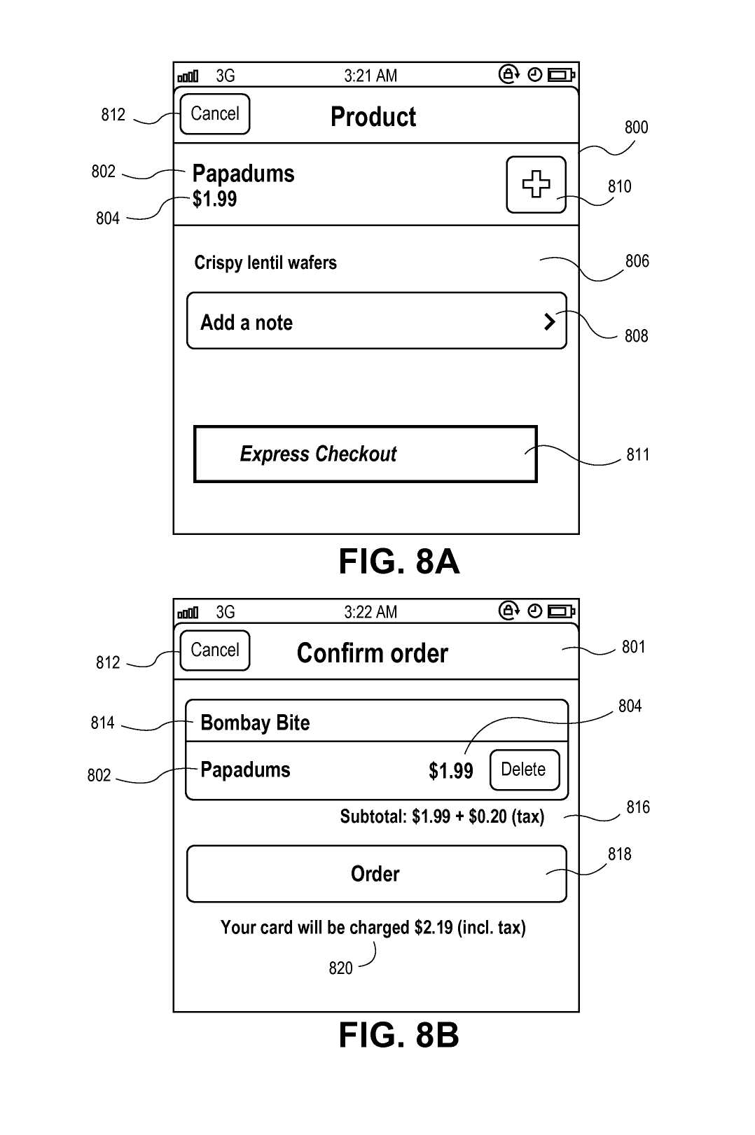

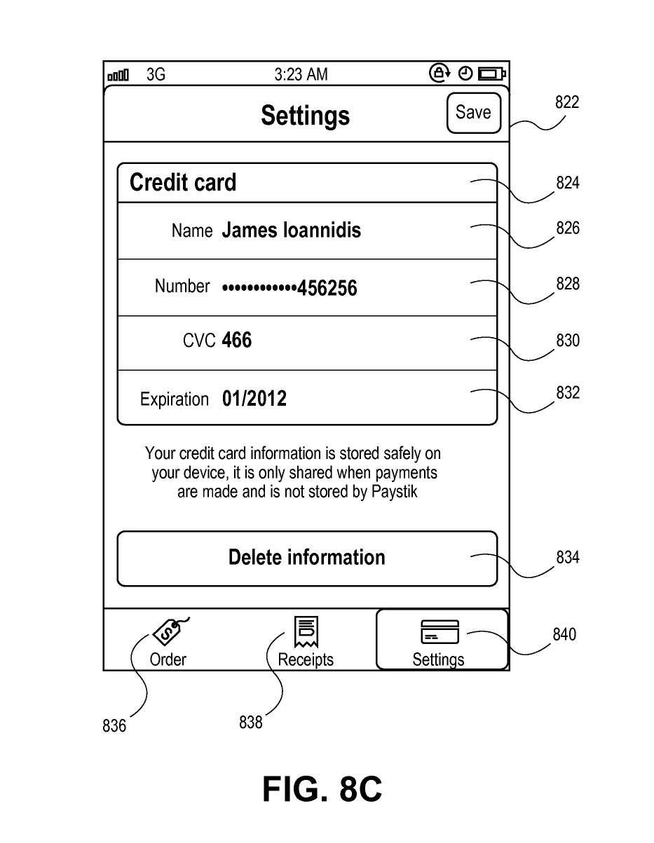

As one skilled in the art will appreciate, each of the relational tables may be used to construct GUIs as described for the program product above that allow a consumer user to interact with the computer program of the instant invention, and exemplary GUIs and their functions will be described with reference to FIGS. 8A-8C.

FIG. 8A is a graphical user interface (“GUI”) displaying a mobile device scanning display 800 according to an embodiment of the invention. As can be seen, the GUI includes a product identifier 802, e.g., the product name, and the product price 804. Under the product price, product description 806 may also be included, all of which will enable a consumer user to determine if the code has been properly scanned. The product scan page may also include a prompt to add a note 808 to the product before adding the product to the consumer user's cart using the add tab 810. Alternatively, the consumer user may select the express checkout option 811, which will enable to consumer user to transmit immediately the item, etc., to the purchasing server for processing payment. Finally, on this exemplary GUI, the consumer user may cancel the scan using the cancel tab 812. If the consumer user chooses to add the item to their shopping cart, in an exemplary embodiment, the shopping cart GUI 801 shown in FIG. 8B is initiated. As can be seen, the shopping cart GUI 801 includes a merchant name 814, the product identifier 802, the price 804, the price of the product with tax 816, an order tab 818 and an indicator for the total amount a credit card will be charged 820.

In FIG. 8C, the settings GUI 822 used in the invention is displayed. As can be seen, the settings display can include the user credit card information 824, including the user name 826, the user credit card number 828, the user verification code 830, and the credit card expiration date 832. The consumer user may choose to delete credit card information by selecting tab 834 on this GUI, or may view the consumer user's order history 836, receipts 838, and additional settings 840, e.g., shipping addresses, multiple credit cards, suggestion preferences, etc.

As one skilled in the art will further appreciate, the display pages of FIGS. 8A-8C are exemplary of the GUIs that may be initiated by the computer program of the instant invention to perform the inventive functions herein. Other GUIs may be created that will help with efficiency of data entry, add additional features, or further enable the purchase of products using a mobile device, and accordingly not all embodiments of such GUIs have been described herein, but will be apparent to one of skill in the art. Accordingly, various GUIs may be used instead of or in addition to the GUIs described herein, and the GUIs are in no way to be considered limiting to the specification and claims, but are used for a descriptive sense only.

Moreover, in the drawings and specification, there have been disclosed a typical preferred embodiment of the invention, and although specific terms are employed, the terms are used in a descriptive sense only and not for purposes of limitation. The invention has been described in considerable detail with specific reference to these illustrated embodiments. It will be apparent, however, that various modifications and changes can be made within the spirit and scope of the invention as described in the foregoing specification, and such modifications and changes are to be considered equivalents and part of this disclosure.

1. A computer-implemented method comprising:
transmitting, by a first server to a first client device, a scannable code for display on the first client device, the scannable code encoding a session identifier for a session between the first client device and the first server;
receiving, by the first server, a transaction identifier to authenticate a transaction within the session between the first client device and the first server, wherein the transaction identifier is transmitted to the first server in response to a second client device scanning and decoding the scannable code displayed on the first client device to obtain the session identifier; and
transmitting, by the first server, an indication of a successful authentication to the first client device in response to the received transaction identifier.

2. The computer-implemented method of claim 1, further comprising:
transmitting, by the first server to the first client device, an executable script to cause the first client device to open a communication channel with a second server, wherein the transmission of the transaction identifier to the first server includes the second client device transmitting to the second server the session identifier decoded from the scannable code and user data stored on the second client device, the second server looking up the communication channel using the session identifier, the second server generating the transaction identifier using the received user data, the second server transmitting the transaction identifier to the first client device, and the first client device forwarding the transaction identifier to the first server.

3. The computer-implemented method of claim 2, further comprising:
establishing, by the first server, a communication channel with the second server;
transmitting, by the first server to the second server via the communication channel, a request to confirm the received transaction identifier; and
receiving, by the first server from the second server via the communication channel, confirmation of the transaction identifier, wherein the indication of the successful authentication is transmitted further in response to receiving the confirmation of the transaction identifier.

4. The computer-implemented method of claim 3, wherein the second server, upon confirming the transaction identifier, marks the transaction associated with the session identifier as being complete.

5. The computer-implemented method of claim 1, further comprising:
establishing, by the first server, a communication channel with the second server, wherein the transaction identifier is received by the first server from the second server via the established communication channel, and the transaction identifier includes the session identifier.

6-15. (canceled)

16. A non-transitory computer-readable medium storing instructions which, when executed by one or more processors in a processing device, cause the processing device to perform a method comprising:
transmitting, by a first server to a first client device, a scannable code for display on the first client device, the scannable code encoding a session identifier for a session between the first client device and the first server;
receiving, by the first server, a transaction identifier to authenticate a transaction within the session between the first client device and the first server, wherein the transaction identifier is transmitted to the first server in response to a second client device scanning and decoding the scannable code displayed on the first client device to obtain the session identifier; and
transmitting, by the first server, an indication of a successful authentication to the first client device in response to the received transaction identifier.

17. The non-transitory computer-readable medium of claim 16, the method further comprising:
transmitting, by the first server to the first client device, an executable script to cause the first client device to open a communication channel with a second server, wherein the transmission of the transaction identifier to the first server includes the second client device transmitting to the second server the session identifier decoded from the scannable code and user data stored on the second client device, the second server looking up the communication channel using the session identifier, the second server generating the transaction identifier using the received user data, the second server transmitting the transaction identifier to the first client device, and the first client device forwarding the transaction identifier to the first server.

18. The non-transitory computer-readable medium of claim 17, the method further comprising:
establishing, by the first server, a communication channel with the second server;
transmitting, by the first server to the second server via the communication channel, a request to confirm the received transaction identifier; and
receiving, by the first server from the second server via the communication channel, confirmation of the transaction identifier, wherein the indication of the successful authentication is transmitted further in response to receiving the confirmation of the transaction identifier.

19. The non-transitory computer-readable medium of claim 18, wherein the second server, upon confirming the transaction identifier, marks the transaction associated with the session identifier as being complete.

20. The non-transitory computer-readable medium of claim 17, the method further comprising:
establishing, by the first server, a communication channel with the second server, wherein the transaction identifier is received by the first server from the second server via the established communication channel, and the transaction identifier includes the session identifier.

21. A first server comprising:
a processing device; and
a memory coupled to the processing device, the memory storing instructions which, when executed by the processing device, cause the first server to:
transmit, to a first client device, a scannable code for display on the first client device, the scannable code encoding a session identifier for a session between the first client device and the first server;
receive a transaction identifier to authenticate a transaction within the session between the first client device and the first server, wherein the transaction identifier is transmitted to the first server in response to a second client device scanning and decoding the scannable code displayed on the first client device to obtain the session identifier; and
transmit an indication of a successful authentication to the first client device in response to the received transaction identifier.

22. The first server of claim 21, wherein the execution of the instructions further cause the first server to:
transmit, to the first client device, an executable script to cause the first client device to open a communication channel with a second server, wherein the transmission of the transaction identifier to the first server includes the second client device transmitting to the second server the session identifier decoded from the scannable code and user data stored on the second client device, the second server looking up the communication channel using the session identifier, the second server generating the transaction identifier using the received user data, the second server transmitting the transaction identifier to the first client device, and the first client device forwarding the transaction identifier to the first server.

23. The first server of claim 22, wherein the execution of the instructions further cause the first server to:
establish a communication channel with the second server;
transmit, to the second server via the communication channel, a request to confirm the received transaction identifier; and
receive, from the second server via the communication channel, confirmation of the transaction identifier, wherein the indication of the successful authentication is transmitted further in response to receiving the confirmation of the transaction identifier.

24. The first server of claim 23, wherein the second server, upon confirming the transaction identifier, marks the transaction associated with the session identifier as being complete.

25. The first server of claim 21, wherein the execution of the instructions further cause the first server to:
establish a communication channel with the second server, wherein the transaction identifier is received by the first server from the second server via the established communication channel, and the transaction identifier includes the session identifier.
